(19) United States
(12) Patent Application Publication
(10) Pub. No.: US 2004/0007877 A1
(43) Pub. Date: Jan. 15, 2004

(54) Electret generator apparatus and method

(75) Inventors: Justin Boland, Pasadena, CA (US); Yu-Chong Tai, Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: California Institute of Technology, Pasadena, CA (US); Office of Technology Transfer M/C 210-85, Cal Tech, Pasadena, CA (US)

(21) Appl. No.: 10/455,755

(22) Filed: Jun. 4, 2003

Related U.S. Application Data
(60) Provisional application No. 60/417,698, filed on Oct. 10, 2002.
(60) Provisional application No. 60/388,874, filed on Jun. 13, 2002.
(60) Provisional application No. 60/388,875, filed on Jun. 13, 2002.
(60) Provisional application No. 60/387,181, filed on Jun. 7, 2002.

(51) Int. Cl. H02P 9/04

(52) U.S. Cl. 290/1 R

(57) ABSTRACT

An apparatus for power generation. The apparatus has a first substrate comprising a conductive surface region and a second substrate coupled to the first substrate. Preferably, the second substrate comprises an electret material region, which is characterized by a substantially uniform electric field associated with the electret material region. The conductive substrate and the electret substrate are aligned in a significantly parallel fashion with a common area of each region directly facing the other region (A). A distance (d) characterizing a spatial separation is formed between the conductive surface region and the electret material region. A relative voltage potential (V) between the conductive substrate and the electret substrate is associated with the distance (d). In between the conductive substrate and the electret substrate is a material, liquid, gas, or combination with an associated permittivity (ε₀). The relative voltage potential changes based upon a change in the spatial separation between (d), a change in the overlapping area (A), or a change in the permittivity (ε₀) between the conductive surface region and the electret material region.

### CROSS-REFERENCES TO RELATED APPLICATIONS

This present application claims priority to U.S. Provisional Applications No. 60/387,181 (CIT No. 3703-P) filed Jun. 7, 2002 in the names of Boland and Tai; U.S. Patent Application No. 60/388,875 (CIT No. 3706-P) filed Jun. 13, 2002 in the names of Boland and Tai; U.S. Provisional Application No. 60/388,874 (CIT No. 3705-P) filed Jun. 13, 2002 in the names of Boland, Tai, and Suzuki; and U.S. Provisional Application No. 60/417,698 (CIT No. 3782-P) filed Oct. 10, 2002 in the name of Boland, commonly owned, and hereby incorporated by reference for all purposes.

### STATEMENT AS TO RIGHTS TO INVENTIONS MADE UNDER FEDERALLY SPONSORED RESEARCH OR DEVELOPMENT

This work was partially supported by DARPA under Award Number DAAHO1-01-R002 and by the Engineering Research Centers Program of the National Science Foundation under Award Number EEC-9402726

### BACKGROUND OF THE INVENTION

The present invention generally relates to power generation techniques. More particularly, the invention provides an apparatus and method for power generation using an electret device having improved electrical properties for generation of electrical power. Merely by way of example, the electret device has been fabricated using a patterning process including micromachining processes. But it would be recognized that other processes such as molding, casting, laser ablation, direct printing, etc. can also be used. Additionally, electret power generation apparatuses and methods can come in a variety of shapes and sizes to efficiently output power for small sized devices.

Electromagnetic generators have been used to supply power to a variety of applications. Extremely large power generators exist, such as those providing power using movement of water from large rivers that have been controlled by dams. As merely an example, Hoover Dam produces electricity for Los Angeles, Calif., United States of America. Alternatively, electromagnetic generators can be small to supply power to operate certain electronic features of automobiles, home appliances, and personal appliances. Other types of generators also exist.

As merely an example, one type of electromagnetic generator is a direct current (DC) generator. Often times, the DC generator uses a conductor-bearing rotating member called an armature that converts mechanical kinetic energy into electrical energy as it is rotated within a magnetic field. Such conversion is provided when mechanical force is applied to the armature which upon rotation within the field generates electric energy including voltage and current. The voltage and current can then be used to power external devices as it is passed through external circuitry. Further details of the theory and operation of the electromagnetic generator can be found in The Bureau of Naval Personal, BASIC ELECTRICITY, Second Revised and Enlarged Edition, Dover Publications, Inc., New York (1969), among other sources.

Although highly effective for certain applications, electromagnetic generators have limitations as they become smaller and smaller. As merely an example, electromagnetic generators have been ineffective for providing power for applications having a form factor of less than one cubic centimeter. As the size of the conventional armature becomes less than a predetermined amount, about one inch or so, conventional electromagnetic generators typically cannot provide sufficient power to operate such modern electronic devices as cell phones, personal digital assistants, pagers, pace makers, and the like.

As merely an example, one of the smallest known commercial electromagnetic generators being used has been developed by Seiko Corporation of America for use in its Kinetic Series of watches. The peak power output from these generators is less than 40 microwatts, and thus is not sufficient for continuous operation of the watch hands. To emphasize the problem, Seiko must often use a backup system inside their watches as well as many power saving techniques to enable their Kinetic Series watches to keep time. Functionality of the watch is sacrificed due to the lack of a sufficient power supply. Accordingly, modern electronic devices still rely on power from chemical power sources such as batteries, which often have a fixed life, are difficult to charge, and cumbersome.

Accordingly, electret generators are proposed to provide a scalable power solution suitable for use in a wide array of applications and devices. These electromotive force required for electret generators is purely electric, and does not require the electromagnetic force used by conventional electromagnetic generators. Electret generator theory and experiments have been reported by 0. D. Jefimenko, IEEE Trans. Ind. Appl., Vol. IA-14, pp. 537-540, 1978 and by Y. Tada, IEEE Trans. Elect. insul. EI-21, 1986, pp. 457-464. An electret generator with a radius of 45 mm was studied by Y. Tada, Jpn. J. Appl. Phys., Vol. 31, Part 1, No. 3, 1992, pp. 846-851. Here, a maximum reported power output from an electret generator was 1.02 mW. Unfortunately, conventional electret generators still lack a capability of becoming smaller and more effective and have generally not seen any commercial use. These and other limitations are described in further detail throughout the present specification and more particularly below.

From the above, it is seen that improved techniques for power generation are highly desirable.

### BRIEF SUMMARY OF THE INVENTION

According to the present invention, techniques for power generation are provided. More particularly, the invention provides an apparatus and method for power generation using an electret device having improved electrical properties for generation of electrical power. Merely by way of example, the electret device has been fabricated using a patterning process including micromachining processes. But it would be recognized that other processes such as molding, casting, laser ablation, direct printing, etc. can also be used. Additionally, electret power generation apparatus and methods can come in a variety of shapes and sizes to efficiently output power for small sized devices. Here, the term electret can be defined as a dielectric material exhibiting a quasi-permanent electrical charge. The term quasi-permanent means that the time scales characteristic of the decay of the charge are much longer than the time periods over which studies are performed with the electret. Alternatively, other definitions for electret can also be used, depending upon the embodiment without departing from the spirit of the scope of the claims herein.

In a specific embodiment, the invention provides a method for generating energy using an electret material. The method includes moving an electret material surface relative to a conductive region. Depending upon the embodiment, the electret material can be moved or the conductive region can be moved, alternatively both the electret material and the conductive region can be moved in a spatial manner relative to each other. The conductive region being less than 20 square centimeters, but can also be at other dimensions, depending upon the application. The method causing a change in a voltage potential of the conductive region relative to the electret potential occurs when there is relative movement of the electret material surface to the conductive region.

In an alternative specific, the invention provides an apparatus for generating energy. Preferably, the apparatus is configured as a micro-generator, which has a small form factor. The apparatus includes an electret material surface and a conductive surface region facing the electret material surface at a fixed distance. A dielectric material is operably coupled between the electret surface and the conductive surface region to cause a potential at the conductive surface region to change based upon the spatial position of the dielectric material relative to the electret material. Depending upon the embodiment, the dielectric material can be a liquid, solid, gas, or combination of these, which moves in and out of a region between the electret material surface and the conductive surface region.

In an alternative specific embodiment, the invention provides an apparatus for power generation. The apparatus has two substrates. The first substrate comprises a conductive surface region and a second substrate is coupled to the first substrate. Preferably, the second substrate comprises an electret material region, which is characterized by a substantially uniform electric field associated with the electret material region. A distance (d) characterizing a spatial separation is formed between the conductive surface region and the electret material region. A voltage potential between these regions is associated with the distance (d). The voltage potential changes based upon changes in the spatial separation between the conductive surface region and the electret material region.

Numerous benefits are achieved using the present invention over conventional techniques. The invention can be implemented using conventional process technology. In other embodiments, the invention can be provided using a micromachined electret structure, which can be used for a variety of power applications. Micromachining also allows for smaller design sizes, which can be mass produced, for power generators while not compromising its ability to generate desired amounts of voltage and current. Depending upon the embodiment, one or more of these benefits may be achieved. These and other benefits are described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of an electret power generation apparatus according to an embodiment of the present invention;

FIG. 2 is a simplified diagram of an alternative electret power generation apparatus according to an embodiment of the present invention;

FIG. 3 is a simplified diagram of still another alternative electret power generation apparatus according to an embodiment of the present invention;

FIG. 4 is a simplified diagram of yet another alternative electret power generation apparatus according to an embodiment of the present invention;

FIG. 5 is a simplified diagram of a method of electret power generation according to an embodiment of the present invention;

FIG. 6 is a simplified circuit diagram of an electret power generation apparatus according to an embodiment of the present invention;

FIG. 7 is a simplified diagram of a electret generator according to an embodiment of the present invention;

FIG. 8 is a simplified process flow for manufacturing an electret device according to an embodiment of the present invention;

FIG. 9 is a simplified diagram of a charge density distribution for the electret device according to an embodiment of the present invention;

FIG. 10 is a simplified diagram of an electret apparatus according to an embodiment of the present invention;

FIG. 11 is a plot of power against speed according to an embodiment of the present invention; and

FIG. 12 is a top-view diagram of an element in an electret generator according to an embodiment of the present invention

### DESCRIPTION OF THE SPECIFIC EMBODIMENTS

According to the present invention, techniques for power generation are provided. More particularly, the invention provides an apparatus and method for power generation using an electret device having improved electrical properties for generation of electrical power. Merely by way of example, the electret device has been fabricated using a patterning process including micromachining processes. But it would be recognized that other processes such as molding, casting, laser ablation, direct printing, etc. can also be used. Additionally, electret power generation apparatus and methods can come in a variety of shapes and sizes to efficiently output power for smaller sized devices. Here, the term electret can be defined as a dielectric material exhibiting a quasi-permanent electrical charge. The term quasi-permanent means that the time scales characteristic of the decay of the charge are much longer than the time periods over which studies are performed with the electret. Alternatively, other definitions for electret can also be used, depending upon the embodiment without departing from the spirit of the scope of the claims herein.

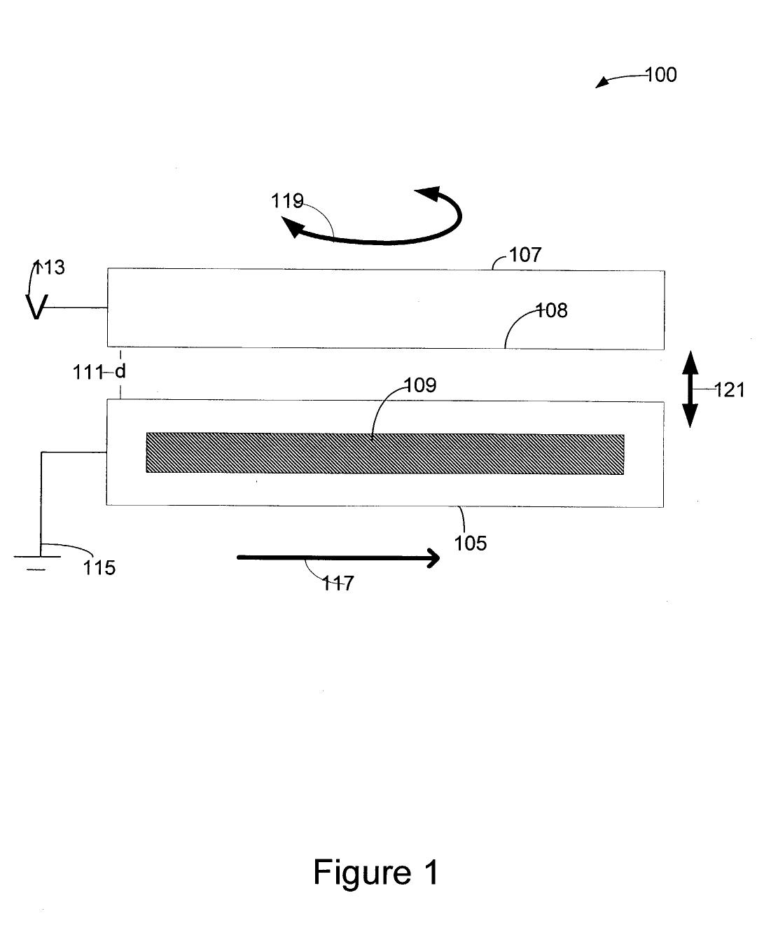

FIG. 1 is a simplified diagram of an electret power generation apparatus 100 according to an embodiment of the present invention. This diagram is merely an example, which should not unduly limit the scope of the claims herein. One of ordinary skill in the art would recognize many variations, alternatives, and modifications. As shown, the apparatus includes a first substrate 107, which has a conductive surface region 108. The first substrate can be made of any suitable material that is sufficiently rigid and can include conductive characteristics. For example, the substrate can be made of a metal, a plastic, a semiconductor, or any combination of these. Conductive regions can be formed on the substrate and/or an inherent characteristic of the substrate depending upon the application. Preferably, the substrate is an oxidized silicon crystal coated with aluminum, but can also be made of other materials. The apparatus also has a second substrate 105 coupled to the first substrate, as shown.

Preferably, the second substrate comprises an electret material region 109, which is characterized by a substantially uniform electric field associated with the electret material region. The electret material region is a micromachined structure, which allows for smaller form factors, in specific embodiments. Preferably, the apparatus includes an electret device, which has been described in more detail in co-pending U.S. patent application Ser. No. ______ (Attorney Docket No. 020859-001710US, commonly owned, and hereby incorporated by references for all purposes. The device has a thickness of substrate material having a contact region. An electrically floating conducting region is formed overlying the thickness of substrate material. The floating conducting region is free from physical contact with the contact region. A protective layer is formed overlying the floating conductive region. The protective layer has a surface region and seals the floating conducting region. The thickness of substrate material, floating conducting region, and protective layer form a sandwiched structure having an apparent charge density of at least 1×10⁻⁴ Coulombs/m² in magnitude and a peak to peak electric field non-uniformity of 5% and less as measured directly above the protective layer. Of course, one of ordinary skill in the art would recognize many alternatives, variations, and modifications.

In a specific embodiment, the electret material region and the conductive surface region are configured to cause a change in voltage leading to power generation when their spatial separation changes. The electret material region and the conductive surface region are substantially parallel to each other in the preferred embodiment. A distance (d) 111 characterizing a spatial separation is formed between the conductive surface region and the electret material region. As also shown, a relative voltage potential (V) 113 to 115 is associated with the distance (d). The relative voltage potential changes based upon a movement in the spatial separation between the conductive surface region and the electret material region. Depending upon the embodiment, there can be various ways to move the first substrate relative to the second substrate. The first substrate can be fixed while the second substrate moves in a spatial manner relative to the second substrate. Alternatively, the second substrate can be fixed while the first substrate moves in a spatial manner relative to the second substrate. Alternatively, each of the substrates can be moved relative to each other where each of the substrates is movable and not fixed. Alternatively, any combination of these ways of moving the first substrate relative to the second substrate may be used depending upon the application.

The apparatus generates voltage depending upon a particular motion of the first substrate and in particular the conductive region relative to the electret material region in the second substrate. In a specific embodiment, the relative movement between the two substrates can be translational, which is illustrated by the direction line shown by reference numeral 117. Alternatively, the relative movement between the two substrates can be rotational, which is illustrated by the direction line shown by reference numeral 119. Alternatively, the relative movement between the two substrates can be translational along the spacing d, which is illustrated by the direction line shown by reference numeral 121. Alternatively, the relative movement can be any combination of these ways of moving the direction of one substrate relative to another substrate. Here, the movement can be any combination of rotational, translational, and possibly vibrational to cause the voltage to change based upon application of the electric field of the electret material region onto the conductive region. Further details of methods of forming power are described throughout the present specification and more particularly below.

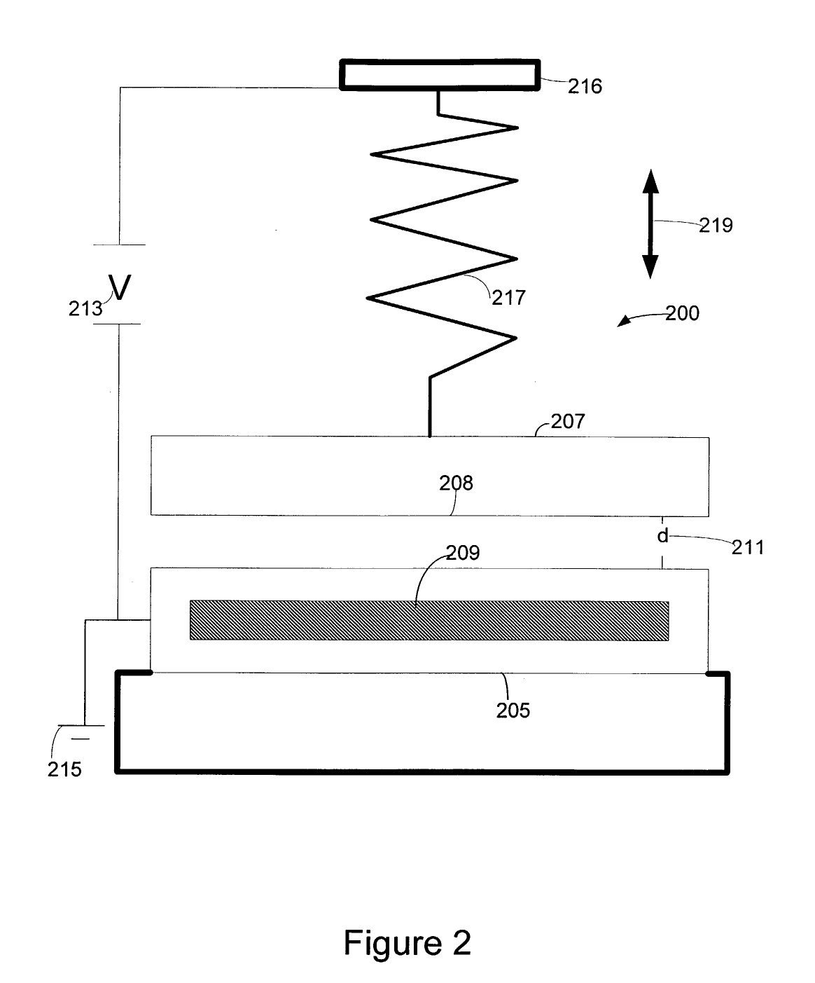

FIG. 2 is a simplified diagram of an alternative electret power generation apparatus 200 according to an embodiment of the present invention. This diagram is merely an example, which should not unduly limit the scope of the claims herein. One of ordinary skill in the art would recognize many variations, alternatives, and modifications. As shown, the apparatus includes a first substrate 207, which has a conductive surface region 208. The first substrate can be made of any suitable material that is sufficiently rigid and includes conductive characteristics. For example, the substrate can be made of a metal, a plastic, a semiconductor, or any combination of these. Conductive regions can be formed on the substrate and/or an inherent characteristic of the substrate depending upon the application. Preferably, the substrate is a an oxidized silicon crystal coated with aluminum, but can also be made of other materials. The apparatus also has a second substrate 205 coupled to the first substrate, as shown.

Preferably, the second substrate comprises an electret material region 209, which is characterized by a substantially uniform electric field associated with the electret material region. The electric material region is a micromachined structure, which allows for smaller form factors, in specific embodiments. Preferably, the apparatus includes an electret device, which has been described in more detail in co-pending U.S. patent application Ser. No. ______ (Attorney Docket No. 020859-001710US, commonly owned, and hereby incorporated by references for all purposes. The device has a thickness of substrate material having a contact region. An electrically floating conducting region is formed overlying the thickness of substrate material. The floating conducting region is free from physical contact with the contact region. A protective layer is formed overlying the floating conductive region. The protective layer has a surface region and seals the floating conducting region. The thickness of substrate material, floating conducting region, and protective layer form a sandwiched structure having an apparent charge density of at least 1×10⁻⁴ Coulombs/m² in magnitude and a peak to peak electric field non-uniformity of 5% and less as measured directly above the protective layer. Of course, one of ordinary skill in the art would recognize many alternatives, variations, and modifications.

In a specific embodiment, the electret material region and the conductive surface region are configured to cause a change in voltage leading to power generation. The electret material region and the conductive surface region are substantially parallel to each other in the preferred embodiment. A distance (d) 211 characterizing a spatial separation is formed between the conductive surface region and the electret material region. As also shown, a voltage potential (V) 213 relative potential 215 is associated with the distance (d). The relative voltage potential changes based upon a movement in the spatial separation between the conductive surface region and the electret material region. Depending upon the embodiment, there can be various ways to move the first substrate relative to the second substrate. The first substrate can be fixed while the second substrate moves in a spatial manner relative to the second substrate. Alternatively, the second substrate can be fixed while the first substrate moves in a spatial manner relative to the second substrate. Alternatively, each of the substrates can be moved relative to each other and each of the substrates is movable and not fixed. Alternatively, any combination of these ways of moving the first substrate relative to the second substrate may be used depending upon the application.

The apparatus generates voltage depending upon a particular motion of the first substrate and in particular the conductive region relative to the electret material region in the second substrate. In a specific embodiment, the second substrate including the electret material is fixed. The first substrate including the conductive region is coupled to fixed structure 216 via spring 217. The spring connects the fixed structure to the first substrate. Preferably, the spring allows the first substrate to return to a home position by providing restoring force or allows the first substrate to move in a vibrational manner in a spatial direction illustrated by reference numeral 219. Movement of the first substrate can also occur using acceleration forces applied to the first substrate using movement or gravity, depending upon the application. By way of the vibrational movement, power can be generated using apparatus 200. Further details of methods of forming power are described throughout the present specification and more particularly below.

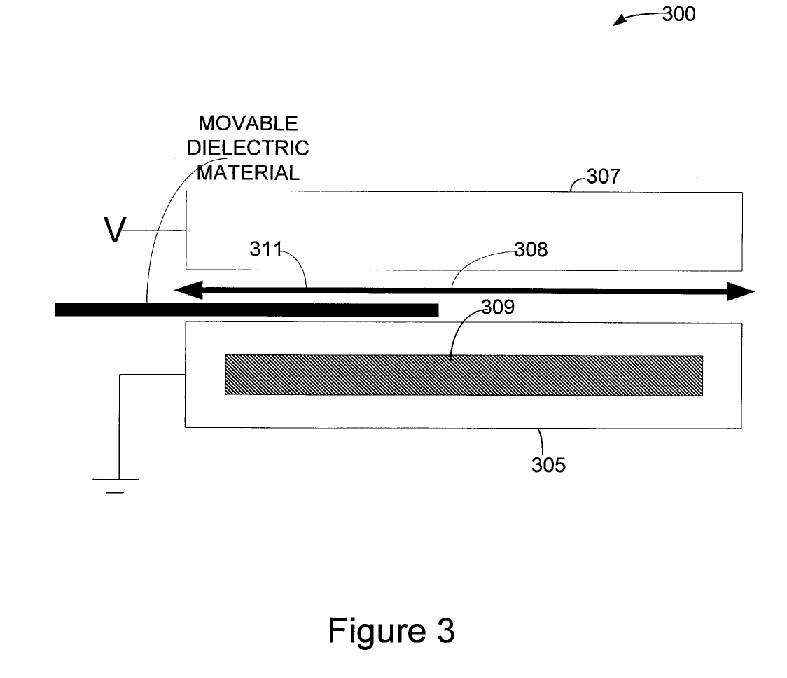

FIG. 3 is a simplified diagram of still an alternative electret power generation apparatus 300 according to an embodiment of the present invention. This diagram is merely an example, which should not unduly limit the scope of the claims herein. One of ordinary skill in the art would recognize many variations, alternatives, and modifications. As shown, the apparatus includes an electret material surface 309 of a first substrate 305 and a conductive surface region 308 of a second substrate 307. The conductive surface region faces the electret material surface. A dielectric material 308 is operably coupled between the electret surface and the conductive surface region to cause a potential at the conductive surface region to change based upon the spatial position of the dielectric material relative to the electret material. As merely an example, charge (Q) that builds up is represented as follows:

Q=ε₀V(A/d)

where

Q is charge;

ε₀ is permittivity;

V is voltage;

A is area of the surface region of the substrate; and

d is the spacing between the first and second substrates.

The dielectric constant changes the permittivity, which then changes the voltage V. Depending upon the embodiment, the dielectric material can be a liquid, solid, or even a gas, which moves in and out of a region between the electret material surface and the conductive surface region. Here, liquid may be inserted between the two substrates to change the permittivity value. Alternatively, a plate of dielectric material can also be inserted between the substrates. Preferably, the dielectric material moves in and out of the spacing in a direction illustrated by reference numeral 311.

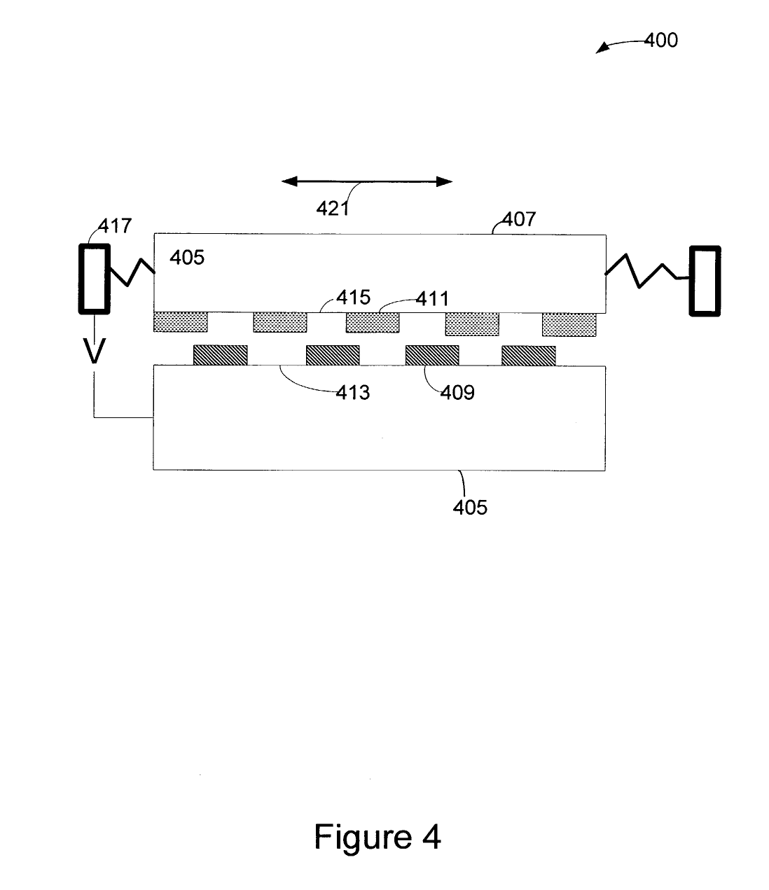

FIG. 4 is a simplified diagram of yet another alternative electret power generation apparatus 400 according to an embodiment of the present invention. This diagram is merely an example, which should not unduly limit the scope of the claims herein. One of ordinary skill in the art would recognize many variations, alternatives, and modifications. As shown, the apparatus includes a first substrate 407, which has a plurality of conductive surface regions 411, each of which is separated by a non-conductive region 415. The first substrate can be made of any suitable material that is sufficiently rigid and includes conductive characteristics. For example, the substrate can be made of a metal, a plastic, a semiconductor, or any combination of these. Conductive regions can be formed on the substrate and/or an inherent characteristic of the substrate depending upon the application. Preferably, the substrate is an oxidized silicon crystal coated with aluminum, but can also be made of other materials. Additionally, the conductive regions are made of a metal such as copper, iron, aluminum, alloys of these materials, and others. The apparatus also has a second substrate 405 coupled to the first substrate, as shown.

Preferably, the second substrate comprises a plurality of electret material regions 409, which are characterized by a substantially uniform electric field. Each of the electret material regions is separated by a non-electret region 413, which is free from an electric field. The electret material region is a micromachined structure, which allows for smaller form factors, in specific embodiments. Preferably, the apparatus includes an electret device, which has been described in more detail in co-pending U.S. patent application Ser. No. ______ (Attorney Docket No. 020859-001710US, commonly owned, and hereby incorporated by references for all purposes. The device has a thickness of substrate material having a contact region. An electrically floating conducting region is formed overlying the thickness of substrate material. The floating conducting region is free from physical contact with the contact region. A protective layer is formed overlying the floating conductive region. The protective layer has a surface region and seals the floating conducting region. The thickness of substrate material, floating conducting region, and protective layer form a sandwiched structure having an apparent charge density of at least 1×10⁻⁴ Coulombs/m² in magnitude and a peak to peak electric field non-uniformity of 5% and less as measured directly above the protective layer. Of course, one of ordinary skill in the art would recognize many alternatives, variations, and modifications.

In a specific embodiment, the electret material region and the conductive surface region are configured to cause a change in voltage leading to power generation. The electret material regions and the conductive surface regions are substantially parallel to each other in the preferred embodiment. A distance (d) characterizing a spatial separation is formed between the conductive surface regions and the electret material regions. As also shown, a relative voltage potential (V) is associated with the distance (d). The relative voltage potential changes based upon a lateral movement (as illustrated by reference numeral 421) between the conductive surface regions and the electret material regions. Depending upon the embodiment, there can be various ways to move the first substrate relative to the second substrate. The first substrate can be fixed while the second substrate moves in a spatial manner relative to the second substrate. Alternatively, the second substrate can be fixed while the first substrate moves in a spatial manner relative to the second substrate. Alternatively, each of the substrates can be moved relative to each other and each of the substrates is movable and not fixed. Alternatively, any combination of these ways of moving the first substrate relative to the second substrate may be used depending upon the application.

The apparatus generates voltage depending upon a particular motion of the first substrate and in particular the conductive regions relative to the electret material regions in the second substrate. In a specific embodiment, the second substrate including the electret material regions is fixed. The first substrate including the conductive region is coupled to fixed structures 417 via springs 419. A spring is connected to each side of the first substrate and is also connected to the fixed structure. Preferably, the spring allows the first substrate to return to a home position or allows the first substrate to move in the lateral manner and then return to a home position. Movement of the first substrate can also occur using acceleration forces applied to the first substrate using movement or gravity, depending upon the application. By way of the movement, power can be generated using apparatus 400. Further details of methods of forming power are described throughout the present specification and more particularly below.

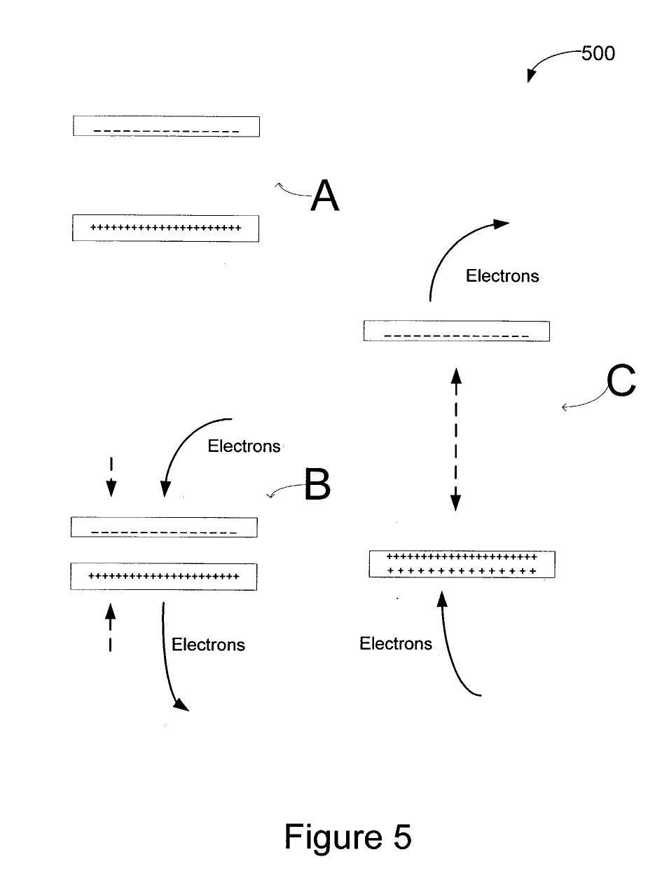

FIG. 5 is a simplified diagram of a method of electret power generation according to an embodiment of the present invention. This diagram is merely an example, which should not unduly limit the scope of the claims herein. One of ordinary skill in the art would recognize many variations, alternatives, and modifications. As shown, the two substrates, including conductive region and electret region, are provided at a predetermined distance as illustrated by reference letter A. Here, positive charges accumulate on the electret region and electrons accumulate on the conductive region. As the two places come together, which reduce a distance d between the two substrates, electrons flow out of the substrate associated with the electret region and flow into the substrate including the conductive region, as illustrated by reference letter B. Now as the two substrates become separated from each other, electrons flow into the electret region, which had become more positively charged, and electrons flow out of the conductive region, as illustrated by reference letter C. Depending upon the embodiment, there are other variations, modifications, and alternatives.

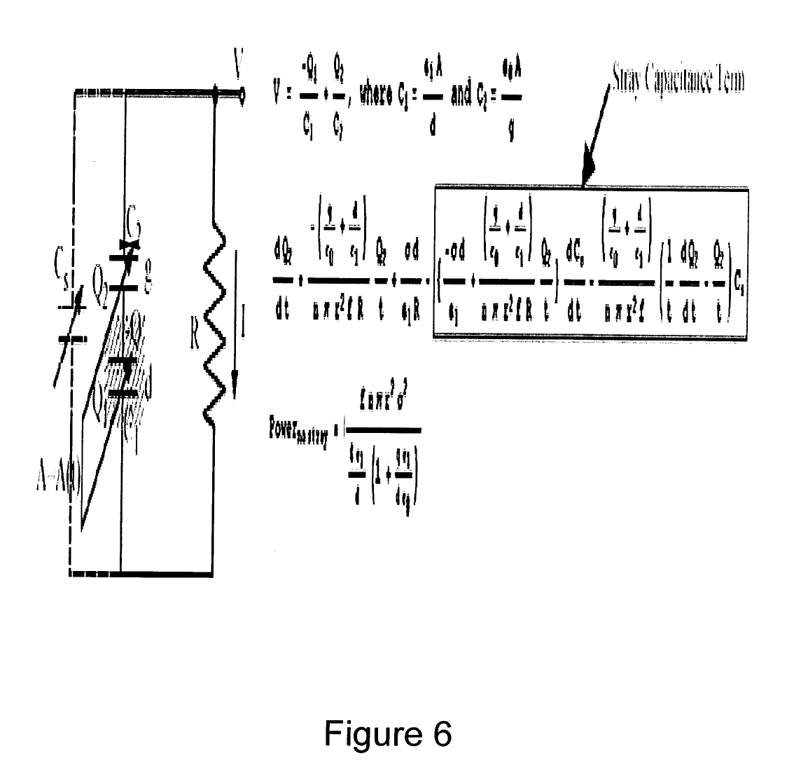

FIG. 6 is a simplified circuit diagram of an electret power generation apparatus according to an embodiment of the present invention. This diagram is merely an example, which should not unduly limit the scope of the claims herein. One of ordinary skill in the art would recognize many variations, alternatives, and modifications. As merely an example, a generator apparatus having a spinning rotor in front of an electret stator, creating a variable-capacitance, fixed charge circuit to generate electrical power is shown by the circuit diagram. Further details of a sample power generator is provided in more detail throughout the present specification and more particularly below.

Although the above method is illustrated using a selected sequence of steps, it would be recognized that various modifications, alternatives, and variations exist. For example, some of the steps may be combined. Further ways of performing a method of fabricating an electret material and making the generator itself can be found throughout the present specification and more particularly below.

Experiments:

To prove the principle and operation of the present invention, we performed experiments. These experiments are merely examples, and should not limit the scope of the claims herein. One of ordinary skill in the art would recognize many variations, alternatives, and modifications. Such experiments used a micromachined rotational electret power generator, and linearized theoretical model of electret power generation. The electret power generator was made using electret materials, such as those noted above. Additionally, we provided a method to produce uniformly charged electret.

As noted in the background, electret generators generally differ from electromagnetic generators in that the electromotive force is purely electric. Electret generator theory and experiment was reported by O. D. Jefimenko, IEEE Trans. Ind. Appl., Vol. IA-14, pp. 537-540, 1978, and by Y. Tada, IEEE trans. Elect. Insul. EI-21, 1986, pp. 457-464. An electret generator with a radius of 45 mm was studied by Y. Tada, Jpn. J. Appl. Phys., Vol. 31, Part 1, No. 3, 1992, pp. 846-851. A maximum reported power output from an electret generator was 1.02 mW. We miniaturized this technology including the use of micromachining and a compatible electret technology, and achieved power generation greater than 1 mW.

As an electret, a Teflon® material (where the term TEFLON® is a registered trademark of E. I. du Pont de NeMours and Company) can contain charge densities of −5×10⁻⁴ C/m² with theoretical lifetimes of hundreds of years (J. A. Malecki, Phys. Rev. B. Vol. 59, no. 15, 1999, pp. 9954-9960). We used Teflon AF 1601-S because it is a spin-on dielectric compatible with MEMS processes. We extended our processing capabilities to allow for multiple spins of this material and also patterning using photoresist. Electrons can then be quickly implanted utilizing a back lighted thyratron (BLT) T. Y. Hsu, “A Novel Electron Beam Source Based on the Back-Lighted Thyratron”, Ph.D. dissertation, Univ. Southern California, 1992, also called a psuedospark device in literature K. Frank, E. Dewald, C. Bickes, U. Ernst, M. Iberler, J. Meier, U. Prucker, A. Rainer, M. Schlaug, J. Schwab, J. Urban, W. Weisser, and D. H. H. Hoffmann, IEEE trans. on Plasma Science, Vol. 27, No. 4, 1999, pp. 1008-1020. Further details of our design and fabrication processes according to the present experiments are provided below.

Rotors were made with a radius of 4 mm and stators with a radius of 5 mm. Design size was chosen to achieve an available area on a 1 cm² chip. The rotor is 4 mm in radius so that surface contact to the ground layer of the stator is possible with silver paste. Since only regions where the rotor and stator overlap result in the production of electricity, for all practical purposes, an effective radius (r_{eff}) of 4 mm is used.

The number of poles in our experiments, n=4, was chosen to compare with results found in literature. In Tada's work, the number of poles remains low due to the method of making them, namely cutting by hand. MEMS lithography is capable of producing lines smaller than 10 μm, which far exceeds the assumptions that fringing fields can be neglected.

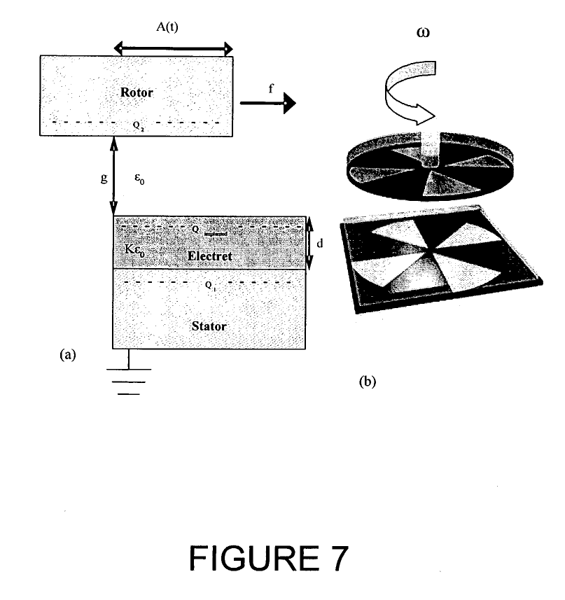

Teflon® material thickness for the generator was 9 μm, and, in contrast to Tada's setup, was on the stator. This configuration was chosen for the ability to try many different thicknesses without having to remount the rotor. The rotor must be mounted with plane normal aligned to the long axis of the axle or else the planes of the rotor and stator cannot be parallel during rotation. The dimensions can be easily seen in FIG. 7. Further details of a process flow for manufacturing the electret material are provided below.

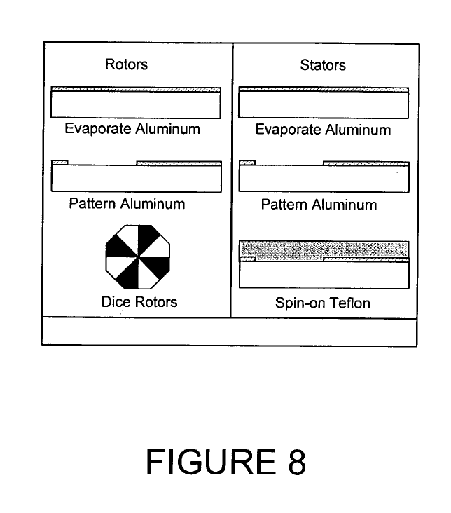

FIG. 8 shows an example of the process flow of a rotor and stator with dielectric. Rotors and stators for electret generators should have a matching number of poles. For the rotor, 2000 \acute{Å} aluminum was evaporated onto a quartz wafer and then patterned. The wafer was then diced, and one die was diced into an octagonal shape to closer approximate a circular rotor. Stators are produced by first evaporating 2000 \acute{Å} aluminum onto a quartz wafer. The aluminum layer is patterned and then a thick layer of Teflon AF 1601-S is spun on. In previous processing, it was determined that a 1.2 μm Teflon layer can be spun-on if the Teflon™ solution is 6% solids and 94% Fluorinert FC-75, as supplied by Dupont. This thin film initially has a rough surface and after a long prebake at 330° C. for 15 minutes to allow the surface to reflow. Baking at this temperature also has the added effect of removing all solvent, which is a necessary step when spinning multiple layers of Teflon.

Dupont also supplies an 18% solids version of the Teflon AF, but this solution is too viscous for conventional spinning. We made a 7.4% solids mixture by mixing the 18% solids version of Teflon with Fluorinert FC-40. This solution produces spun-on films 9 μm thick at 500 RPM. Fluorinert FC-40 has similar electrical characteristics to Fluorinert FC-75, but FC-40 has a kinematic viscosity 2.75 times higher than FC-75. Furthermore, the 1.2 μm film had height fluctuations greater than 25% while the 9 μm film had variations less than 1%. The main disadvantage of FC-40 is its higher boiling point, which means higher temperatures and longer bake times are required to drive off all solvent from the thicker film Teflon film.

Applying HMDS vapor for 3 minutes to the fully baked, spun-on Teflon modified its naturally hydrophobic nature enough for photoresist to be spun on top of the Teflon material. Further trials also proved that spinning Teflon material on fully baked Teflon material is also possible with use of HMDS. The adhesion between Teflon layers appears to be very good, and often was better than adhesion between thermally evaporated aluminum and the substrate. In the case of a floating metal layer, adhesion between the aluminum that was evaporated on top of Teflon material is sufficient unless the any part of the Teflon-aluminum interface is exposed to solvents. Thus, floating metal layers must be sealed before wet dicing or other wet etch steps occur.

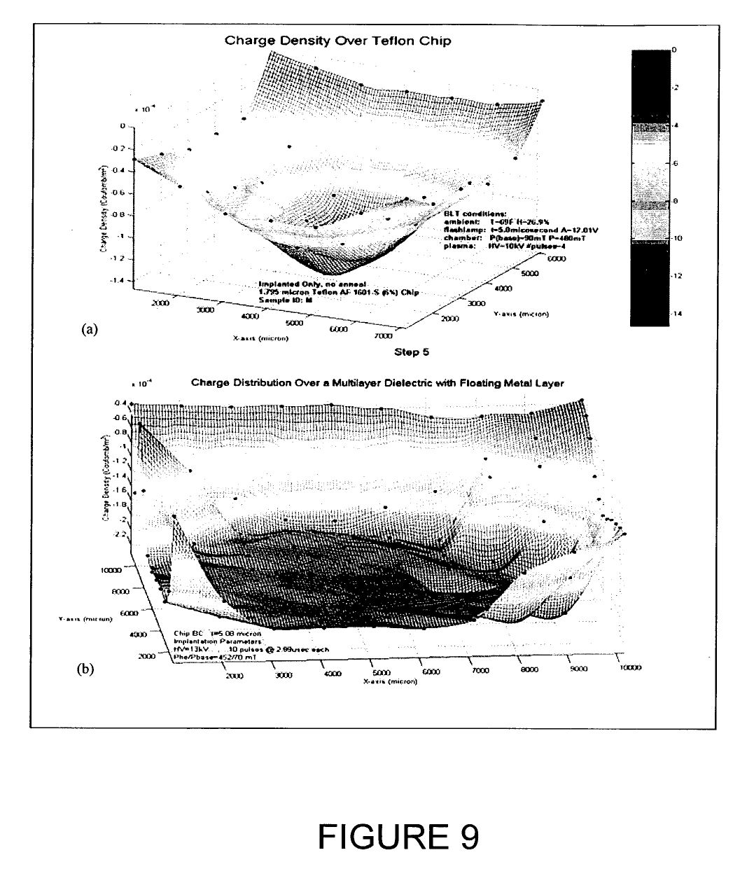

Electron beam implantation is a well-studied method for implanting electrons within dielectrics. Beam writing can be performed by raster scanning over a dielectric; it takes considerable time to implant a sufficient number of electrons while occupying an expensive machine for a menial task using this method. In contrast, a BLT provides a pulsed electron source with very large electron doses within ˜100 ns. Implantation with the BLT produces a Gaussian charge distribution over the surface of the electret, as in FIG. 9(a), which is not desirable for providing a uniform electret. To alleviate this problem, a metal layer is deposited on top of a thick dielectric layer, patterned to be electrically floating Patent pending, and then sealed with a thin dielectric layer. The floating metal layer provides a reference voltage and therefore an electric field non-uniformity of less than 1% of the surface as seen in FIG. 9(b). As further described in FIG. 9, we illustrated (a) charge density of implanted Teflon material using the back lighted thyratron (b) charge implanted in a chip with floating metal layer patterned into a circle, charge outside the metal circle is approximately equal to the Gaussian case.

We measured charge densities with a Monroe Electronics isoprobe Model 244 with a high resolution 1024AEH probe. We mounted the probe on an x-y-z stage to allow precise measurements of the effective surface charge. Minimum observed resolution in x and in y was 244 μm, although the resolution of the stage was 25.4 μm in x-axis and 10 μm in the y-axis. The electret generator relies on an electric field that is fixed in z but variable in x-y, and therefore effective surface charge densities in x-y defined by only the dielectric thickness and the voltage of the surface measured with the isoprobe is sufficient for quantifying the charge.

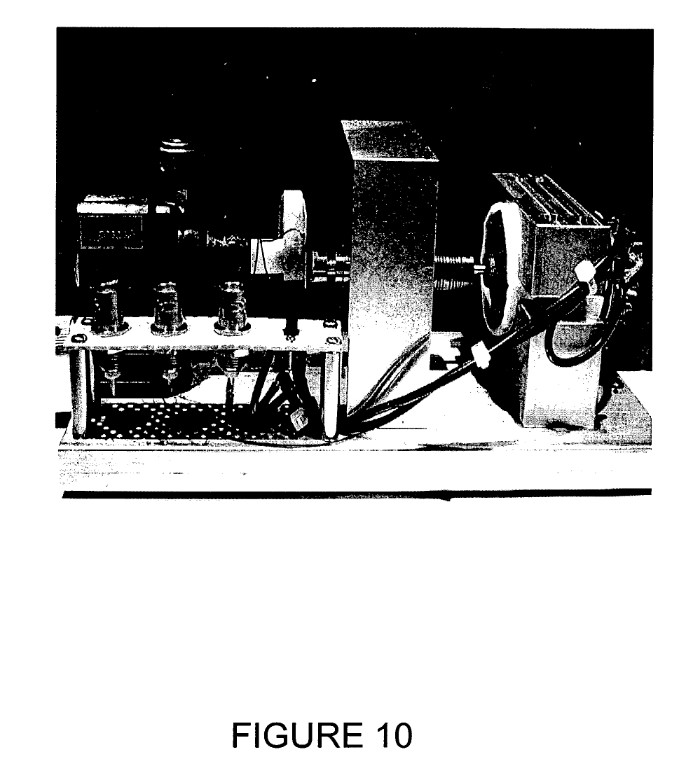

After fabrication of the rotor and stator it is necessary to mount them to an apparatus that can supply rotation. We built a test bed for this purpose (FIG. 10) with an angular misalignment of 0.46 degrees for the rotor, which was measured by shining a laser pointer at the spinning rotor and measuring the radius of the reflected circle and the baseline distance.

A 5-axis micropositioner is used for aligning the stator to the rotor. In trying to minimize the gap spacing, the stator is placed in contact with the rotor at one point, but because of angular misalignment the far end of the rotor is at least 80 μm away from the stator.

Power generation experiments using the test bed involves setting the gap distance, driving the motor at different speeds, and simultaneous measurement of speed and power output. The ground lead of the generator is the ground of the stator and the power lead is the chassis of the test bed which is electrically connected to the rotor through a bearing. The power lead is connected to a simple op-amp, National Semiconductor LF356, in a voltage follower configuration with 1012 Ohm input impedance. This high impedance allows load matching by placing different load resistors across the power and ground. Power output is measured by two different means: (a) voltage output from the amplifier is fed to an HP 54503A 500 MHz digitizing oscilloscope to observe the waveform or (b) voltage output from the amplifier is measured in VRMS with a Fluke 87III True RMS handheld multimeter. Power from the generator is simply V_{RMS}²/R_{L}.

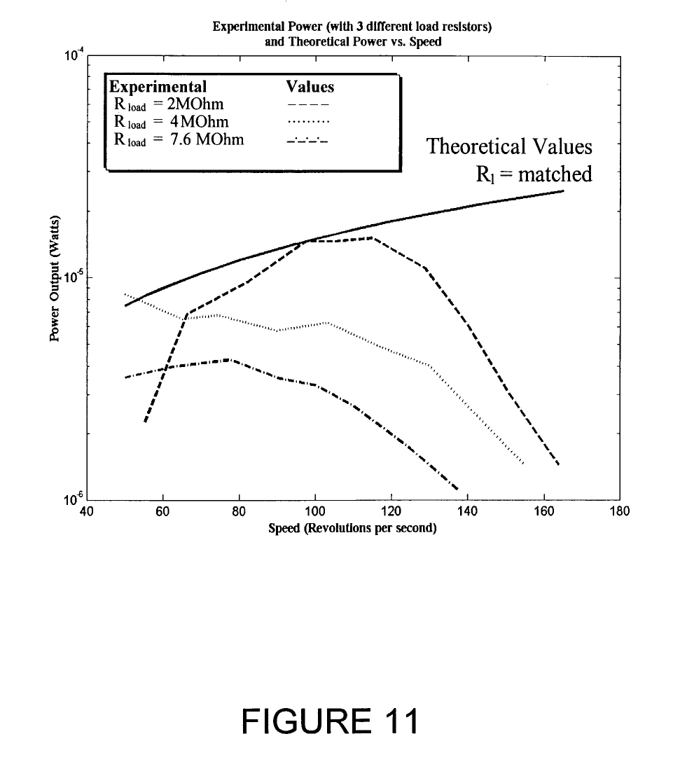

Several methods of measuring the speed were employed to check for accuracy. A stroboscopic tachometer showed some drift from other measurement techniques, so the output waveform from the 4-pole generator was used directly by measuring n=4 periods of the output signal. The motor is a 6-pole motor, and confirmation of speed measurements was made by connecting a secondary channel of the oscilloscope across the terminals of the motor and verifying that 6 periods of back-emf of the motor corresponded to 4 periods of the generator. Additionally, the Fluke handheld multimeter has an option to measure the frequency of an ac signal, which, as expected, was exactly 4 times larger than the frequency acquired from the other methods. The oscilloscope was the primary source of speed measurements. Pulse width modulation was not a viable option to control speed since the motor used draws a current up to 30A. Here, we illustrated in FIG. 11 theoretical values of a continuously load matched system and power output from 3 experimental trials using different load resistances.

Assuming the width of the electrodes is large compared to the distance between them, a linearized theory is derived by assuming that an electret generator acts as a fixed-charge, variable capacitance device. FIG. 8 explained the geometry used in the derivation.

Conservation of charge implies

| | |
|---|---|
| Q_{implanted} = Q₁(t) + Q₂(t) | (1) |

Charge on capacitor is related to the area of the overlapping capacitors.

$$\begin{matrix}{C}_{1} ( t ) = \frac{{K}_{teflon} {ϵ}_{0}}{d} A ( t ) \\ {C}_{2} ( t ) = \frac{{ϵ}_{0}}{g} A ( t ) \end{matrix} \qquad ( 2 )$$

The equation describing the equivalent circuit is

$$\begin{matrix}V ( t ) = \frac{- {Q}_{1} ( t )}{{C}_{1} ( t )} + \frac{{Q}_{2} ( t )}{{C}_{2} ( t )} \\ = ( \frac{- d}{{K}_{teflon} {ϵ}_{0}} ) \frac{Q}{A} + ( \frac{d}{{K}_{teflon} {ϵ}_{0}} + \frac{g}{{ϵ}_{0}} ) \frac{{Q}_{2} ( t )}{A ( t )}\end{matrix} \qquad ( 3 )$$

Where K_{teflon} is the dielectric constant of Teflon AF 1601 listed as 1.93. Since

$$\begin{matrix}V ( t ) = IR = - \frac{\partial {Q}_{2} ( t )}{\partial t} R \\ I ( t ) = \frac{σ d}{{K}_{teflon} {ϵ}_{0} R} - ( \frac{d}{{K}_{teflon} {ϵ}_{0}} + \frac{g}{{ϵ}_{0}} ) \frac{{Q}_{2} ( t )}{A ( t ) R}\end{matrix} \qquad ( 4 )$$

For a rotational geometry neglecting fringing fields,

$$\begin{matrix}A ( t ) = \{ \begin{matrix}\frac{n π {r}^{2 } f}{2} t & for & t : 0 < t < \frac{1}{2 n f} \\ - \frac{n π {r}^{2 } f}{2} t & for & t : \frac{1}{2 n f} < t < \frac{1}{n f}\end{matrix} \\ Let α = ( \frac{d}{{K}_{teflon} {ϵ}_{0}} + \frac{g}{{ϵ}_{0}} ) \frac{1}{n π {r}^{2 } f R} and \\ β = \frac{σ d}{{K}_{teflon} {ϵ}_{0} R} & ( 5 ) \\ Then {Q}_{2} ( t ) = \frac{β t}{1 + α} - {Ct}^{- α} & ( 6 )\end{matrix}$$

With capacitor plates completely out of phase at t=0, Q₂(0)=0

$$I ( t ) = \frac{- σ \frac{d}{{ϵ}_{0}}}{R + \frac{1}{n π {r}^{2 } f } ( \frac{d}{{K}_{teflon} {ϵ}_{0}} + \frac{g}{{ϵ}_{0}} )} \qquad ( 7 )$$

Maximum power is achieved when

$${R}_{optimal} = \frac{1}{n π {r}^{2 } f } ( \frac{d}{{K}_{teflon} {ϵ}_{0}} + \frac{g}{{ϵ}_{0}} ) \qquad ( 8 )$$

This gives a load-matched power equation

$${P}_{optimal} = \frac{{σ}^{2} n π {r}^{2 } f }{\frac{4 {K}_{teflon} {ϵ}_{0}}{d} ( 1 + \frac{{K}_{teflon} g}{d} )} \qquad ( 9 )$$

Charge density is limited by the dielectric strength of the material. In the case of Teflon AF 1601-S, this value is 20 V/μm. Power output increases with decreasing dielectric constant, which is why Teflon AF with dielectric constant of 1.93 is chosen.

Gap spacing (g) should be minimized but spacing smaller than ¼ of the dielectric thickness is sufficiently small. Therefore, gap spacing is directly related to the thickness of the electret. The thickness of the electret is limited by processing issues for Teflon AF, but if this were not the case then the limiting thickness is related to the breakdown voltage in air.

Power generation experiments were performed and the results are shown in FIG. 26. The experimental curve shown is a load matched curve (Equation 9) and uses a gap spacing of 60 μm. This is very reasonable considering that the minimum spacing is zero at the crashed edge and 80 μm at the far edge. The other parameters used in the theoretical values match the measured values of the generator, which are n=4, r=4 mm, σ=−2.8×10⁻⁴ Coulomb/m², K_{Teflon}=1.93, d=91 μm. The noise in the experimental graphs results from the stator being in contact with the rotor. This was necessary to know the gap spacing exactly. The generator continues to perform well under this condition, despite some wear to the surfaces.

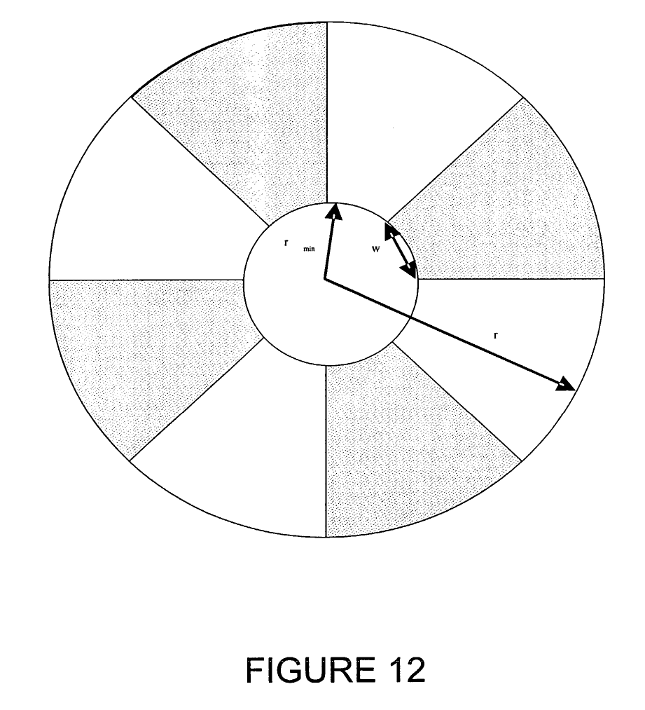

To verify that neglecting the fringing field is a valid assumption, we say that the smallest dimension within 90% of the active generator area must be ten times larger than the gap distance. Since 90% of the effective area of an r=5 mm generator is outside r=1.58 mm, the shortest dimension w (see FIG. 12) is found to be 1.2 mm by using the number of poles and the law of cosines. Assuming w must be ten times larger than g and we previously stated that a decent g is preferably ¼ d, we determined that w need only be 22.5 μm for a 9 μm dielectric thickness. The condition is more than met in our experiments, and by using this argument we expect to see good performance in generators with a few hundred poles.

Uniform charge density, gap control, and dielectric thickness are the primary challenges of designing and producing an electret generator. We engineered solutions to provide uniform charge density on thick, micromachine-compatible dielectric. We derived a linearized theory that adequately models experimental power measurements. Future work will focus on gap spacing, increasing the number of poles, elimination of rotor tilt, and verifying the charge distribution in the z-axis on charge implanted into a floating metal electret. We have already begun work on a test bed-less electret generator that overcomes the aforementioned difficulties by relying more heavily on the advantages of micromachining.

The above example is merely an illustration, which should not unduly limit the scope of the claims herein. One of ordinary skill in the art would recognize many other variations, modifications, and alternatives. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for generating electricity, the method comprising:
moving an electret material surface relative to a conductive region, the conductive region being less than 20 square centimeters;
causing a change in relative voltage potential between the conductive region and the electret based upon at least a movement of the electret material surface relative to the conductive region.

2. The method of claim 1 wherein the conductive region is less than 10 square centimeters.

3. The method of claim 1 wherein the electret material comprises a peak to peak electric field uniformity directly above the surface of 5% and less or 1% and less.

4. The method of claim 1 wherein the electret material and the conductive material are maintained in environment free from moisture, moisture is being 50% RH and less.

5. The method of claim 1 wherein the electret material surface is maintained free from moisture.

6. The method of claim 1 further comprising outputting an alternating electric current from the varying voltage potential.

7. The method of claim 1 wherein the voltage potential difference is at least 1 volt between the conducting region and the electret region

8. The method of claim 1 further comprising applying a mechanical force to facilitate the movement of the electret material relative to the conductive region.

9. The method of claim 1 further comprising generating at least one microwatt of usable power.

10. The method of claim 1 wherein the movement is selected from translational, rotational, or vibrational.

11. Apparatus for generating electricity, the apparatus comprising:
an electret material surface;
a conductive surface region facing the electret material surface;
a dielectric material operably coupled between the electret surface and the conductive surface region to cause the relative potential between the conductive surface region and the electret to change based upon the varying spatial position of the dielectric material.

12. Apparatus of claim 11 wherein the dielectric material is a fluid.

13. Apparatus of claim 12 wherein the dielectric material fluid is water.

14. Apparatus of claim 11 wherein the dielectric material is a solid.

15. Apparatus of claim 11 wherein the conductive surface region further comprises a dielectric or electret material surface.

16. Apparatus of claim 11 wherein the electret material surface and the conductive surface region are separated by a predetermined distance.

17. Apparatus of claim 11 wherein the electret material surface and the conductive surface are configured in a substantially parallel manner.

18. Apparatus of claim 17 wherein the electret surface and the conductive surface include an electric field coupled between the electret surface and the conductive surface, the electric field having a direction normal to the electret surface and the conductive surface.

19. Apparatus of claim 11 wherein the electret material surface is one of a plurality of electret surface regions, each of the surface regions being separated by an inactive region.

20. Apparatus of claim 11 wherein the dielectric material is a conductive liquid.

21. Apparatus for power generation, the apparatus comprising:
a first substrate, the first substrate comprising a conductive surface region;
a second substrate coupled to the first substrate, the second substrate comprising an electret material region, the electret material region being characterized by a substantially uniform electric field associated with the electret material region;
a distance (d) characterizing a spatial separation between the conductive surface region and the electret material region;
a relative voltage potential between the conductive and the electret regions, the voltage potential being associated with the distance (d), whereupon the relative voltage potential changes based upon a change in the spatial separation between the conductive surface region and the electret material region.

22. The apparatus of claim 21 wherein the second substrate comprising:
a thickness of substrate material having a contact region;
a floating conducting region formed overlying the thickness of substrate material, the floating conducting region being free from physical contact with the contact region;
a protective layer formed overlying the floating conductive layer, the protective layer having a surface region, the surface region being free from physical contact with the floating conducting region;
whereupon the thickness of substrate material, the floating conducting region, and the protective layer form a sandwiched structure having a charge density of at least 1×10⁻⁴ Coulombs/m² in magnitude and a peak to peak charge uniformity of 5% and less.

23. The apparatus of claim 22 wherein the floating conducting region is patterned using at least a micromachining process.

24. The apparatus of claim 22 wherein the thickness of substrate material is a Teflon® material having a thickness of about 40 microns and less; wherein the floating conducting region comprises an aluminum bearing material having a thickness of 5000 Angstroms and less.

25. The apparatus of claim 22 wherein the thickness of substrate material comprises Teflon® material.

26. The apparatus of claim 22 wherein the floating conducting region comprises an aluminum bearing material or an aluminum alloy bearing material.

27. The apparatus of claim 22 wherein the protective layer is Teflon®.

28. The apparatus of claim 22 wherein the floating conducting region is a single layer or multiple layers.

29. The apparatus of claim 22 wherein the protective layer is sputtered oxide, a polymer, or SOG.

30. The apparatus of claim 22 wherein the protective layer has a volume resistivity of greater than 1×10¹³ Ohm cm

31. The apparatus of claim 22 wherein the floating conductive layer has a volume conductivity at least 1×10⁻¹⁰ (Ohm cm)⁻¹.

32. The apparatus of claim 22 wherein the conductive layer has a resistivity value less than a resistivity value of the protective layer.

33. The apparatus of claim 22 wherein the charge density is provided by implantation of a plurality of electrons.

34. The apparatus of claim 22 wherein the plurality of electrons are provided by a e-beam.

35. The apparatus of claim 22 wherein the substrate is provided via spinning liquid Teflon® material.

36. The apparatus of claim 22 wherein the substrate is provided via compression molding.

37. The apparatus of claim 22 wherein the substrate is selected from silicon, glass, and plastic.

38. The apparatus of claim 22 wherein the substrate contains an empty region or regions that contain gas or a low-conductivity liquid.

39. The apparatus of claim 22 wherein the substrate is provided on a mounting substrate to hold the substrate in place.

40. The apparatus of claim 38 wherein the mounting substrate comprises an overlying metal layer, the metal layer coupled to the substrate.

41. The apparatus of claim 22 wherein the substrate is made using damascene process.

42. The apparatus of claim 22 wherein floating conductive layer interacts with charge to facilitate the uniform distribution of charge.
